(19) United States
(12) Patent Application Publication
(10) Pub. No.: US 2005/0171222 A1
(43) Pub. Date: Aug. 4, 2005

(54) Polymer foam manufacturing method member for image forming device and image forming device

(76) Inventors: Ryuta Tanaka, Kanagawa (JP); Kenichi Isayama, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/497,596

(22) PCT Filed: Dec. 16, 2002
(86) PCT No.: PCT/JP02/13112

(30) Foreign Application Priority Data
Dec. 19, 2001 (JP) 2001-386321

(51) Int. Cl. C08J 9/00; C08K 3/00

(52) U.S. Cl. 521/50; 521/79; 521/82

(57) ABSTRACT

The present invention provides a method for manufacturing a polymer foam suitable for various members for image-forming devices such as copying machines, facsimile machines, and printers and also provides a member, including a polymer foam manufactured by the method, for image-forming devices and a device, including the member, for forming an image. In a step of forming the polymer foam by allowing a polymer feedstock to foam and curing the feedstock, gas of which the solubility decreases with an increase in temperature is dissolved in the polymer feedstock, which is then heated, whereby the feedstock is allowed to foam and cured. Therefore, the polymer foam has a microcellular surface structure. Furthermore, a high-quality member, having superior surface properties, for image-forming devices can be achieved, and a device for forming an image can be achieved.

### TECHNICAL FIELD

The present invention relates to methods for manufacturing polymer foams, members for image-forming devices, and devices for forming images. The present invention particularly relates to a method for manufacturing a polymer foam suitable for various members for image-forming devices such as copying machines, facsimile machines, and printers and also relates to a member, including the polymer foam manufactured by the method, for image-forming devices and a device, including the member, for forming an image.

### BACKGROUND ART

In recent years, since electrophotography has been advancing, elastic polymer members have been attracting much attention, the members being used for electrification, development, transfer, toner supply, cleaning, and toner control performed in image-forming devices such as dry electrophotographic systems. The elastic polymer members are used as members for such image-forming devices in the form of, for example, elastic rollers such as electrifying rollers, development rollers, transfer rollers, toner supply rollers, and cleaning rollers or elastic blades such as toner control blades and cleaning blades.

In particular, in uses such as transfer components, toner supply components, and cleaning components that must have low hardness, a material for forming such components is preferably an elastic polymer foam. A polymer foam for forming the members for the image-forming devices must have low hardness and a microcellular surface structure.

Examples of a method for forming a known polymer foam include (1) a method in which a foaming agent is used, (2) a mechanical agitation (mechanical froth) method, (3) a desalting method. When, for example, a rubber foam is manufactured, examples of the foaming agent described in item (1) include various carbonates, oxybis(benzenesulfonyl hydrazide) (OBSH), and azodicarbonamide (ADCA), and a foam structure is formed by decomposing those agents to generate gases. When a polyurethane foam is manufactured, examples of the foaming agent include water and organic solvents such as chlorofluorocarbons and chlorofluorocarbon-replacing materials, and foam is generated by allowing water to react with isocyanate to generate CO₂ or vaporizing flon or the like. In the mechanical agitation method described in item (2), a material for forming the polymer foam is agitated so as to contain bubbles, thereby forming foam. In the desalting method described in item (3), a material for forming the rubber foam is compounded with a salt, which is then removed from the resulting material by washing, thereby forming pores.

However, since those known methods have various difficulties, the polymer foam having performance complying with the requirements described above has not been manufactured without production problems.

When a carbonate, which is a foaming agent for forming the rubber foam, is used, uneven cells are formed; hence, the polymer foam has inferior surface properties. When OBSH or ADCA is used, the following problems cannot be avoided: the emission of offensive odors, the deterioration of the work environment, the occurrence of air pollution, and the like. Water, which is a foaming agent for forming a polyurethane foam, is useful in forming low-density foams; however, water has a problem in that high-density foams cannot be readily manufactured and distortion is apt to occur in the cured high-density foams. The use of the chlorofluorocarbons or the like is criticized for causing environmental destruction. For the use of an organic solvent (iso-pentane or the like), there is a problem in that a fire is likely to occur. Furthermore, for the mechanical agitation method, fine uniform foam structures cannot be formed because coarse cells (pin holes) are formed in the polymer foam. For the desalting method, manufacturing cost is high. Therefore, those methods are not suitable for practical use.

Apart from those methods, in order to obtain cells having an extremely small diameter, the following methods have been proposed: for example, a method in which a foaming machine is precisely controlled, a method in which an additive for forming microcells is compounded with a source material for forming foams, and a method in which a foaming agent selected appropriately is used (Japanese Unexamined Patent Application Publication Nos. 9-249760 and 4-163097).

However, even if those methods are used, the microcellular surface structure cannot be achieved without the problems described above; hence, a method for manufacturing a superior polymer foam complying with the requirements described above has been demanded.

In order to solve the above problems, it is an object of the present invention to provide a method for manufacturing a polymer foam that has a microcellular surface structure and is suitable for members for image-forming devices and also provide a member, including a polymer foam manufactured by the method, for image-forming devices and a device, including the member, for forming an image.

### DISCLOSURE OF INVENTION

In order to solve the above problems, the present invention provides a method for manufacturing a polymer foam formed by allowing a polymer feedstock to foam and curing the feedstock. The method includes a step of dissolving gas in the polymer feedstock, the gas being characteristic in that the solubility decreases with an increase in temperature, and a step of heating the polymer feedstock to allow the feedstock to foam and to cure the feedstock, the heating step being subsequent to the dissolving step.

In the present invention, the gas is preferably dissolved in the polymer feedstock at a high pressure and the feedstock is then decompressed, whereby the feedstock is allowed to foam.

The solubility of the gas is, at an atmospheric pressure, preferably 70% or more at a temperature of 25° C. and 45% or less at a temperature of 80° C. In particular, the gas is preferably carbon dioxide.

In the present invention, the polymer feedstock may be replaced with a polyurethane feedstock, whereby a polyurethane foam is manufactured.

The present invention provides a member, including a polymer foam manufactured by the method described above, for image-forming devices.

Furthermore, the present invention provides a device, including the member for image-forming devices, for forming an image.

According to the present invention, the polymer foam having a microcellular surface structure can be manufactured without production problems, which occur in known methods, by making use of the temperature dependence of the solubility of the gas in the polymer feedstock which is in a liquid state. The polymer foam is suitable for members for image-forming devices. Therefore, a high-quality member, having superior surface properties, for image-forming devices can be achieved, and a high-performance device, including the member, for forming an image can be achieved.

### BEST MODE FOR CARRYING OUT THE INVENTION

Particular embodiments of the present invention will now be described in detail.

In a method for manufacturing a polymer foam according to the present invention, it is critical that gas of which the solubility decreases with an increase in temperature is dissolved in a polymer feedstock before the polymer feedstock is allowed to foam and cured.

In general, the solubility of gases in liquids depends on temperature, that is, the solubility is high at a low temperature and low at a high temperature. Therefore, gas dissolved in liquid at a low temperature is formed into fine bubbles in the liquid when the temperature is increased and the solubility is therefore decreased. In the present invention, the polymer foam having fine bubbles can be formed by making use of the nature of the gas solubility described above according to the following procedure: gas is dissolved in a liquid polymer feedstock in advance and the liquid polymer feedstock containing the gas is cured by heating. The polymer foam according to the present invention has an average cell diameter of about 60 to 100 μm.

In the present invention, it is preferable to make use of the temperature dependence of the solubility in addition to the pressure dependence thereof. That is, the gas is dissolved in the polymer feedstock at a high pressure and the polymer feedstock is then decompressed, whereby the polymer feedstock is allowed to foam by making use of the nature of the solubility that is high at a high pressure and low at a low pressure. Therefore, the advantage of a solubility decrease due to an difference in pressure can be obtained in addition to the advantage of a solubility decrease due to an difference in temperature and the foaming effect of the dissolved gas can be appropriately achieved.

The temperature of preparing the polymer feedstock preferably ranges from 10° C. to 60° C. while the gas is dissolved in the polymer feedstock, and the foaming temperature preferably ranges from 10° C. to 240° C. The preparing pressure preferably ranges from 0.8 to 10 atm and the foaming pressure preferably ranges from 0.2 to 4 atm. Thus, it is particularly preferable to prepare the polymer feedstock to allow the resulting polymer feedstock to foam under conditions complying with the temperature and pressure requirements when foaming is performed by making use of a difference in temperature and a difference in pressure.

In the present invention, the key to obtaining the foaming effect is a difference in gas solubility between a step of dissolving the gas in the polymer feedstock and a foaming step, that is, a step of curing the polymer feedstock by heating. Therefore, a combination of temperature and pressure is not particularly limited and any combination of temperature and pressure at which a solubility difference sufficient to establish an appropriate foaming state can be obtained are acceptable.

The gas dissolved in the polymer feedstock is not particular limited and any gas having the following solubilities is preferably used: a solubility of 70% or more, preferably 80% or more, at 25° C. and a solubility of 45% or less, preferably 40% or less, at 80° C. under atomospheric pressure. When the solubility is within the above range, the gas can be dissolved in the polymer feedstock at room temperature and a foaming state can be established at an ordinary heat-curing temperature, that is, a satisfactory foaming state can be readily established under practical conditions. For the solubility described above, the solubility described above must be herein defined as the solubility of the gas in the polymer feedstock in the strict sense; however, the solubility of the gas in water may be used when a hydrophilic source material such as polyether or polyester is used.

Examples of the gas available include, for example, air, nitrogen, and carbon dioxide (a carbonic acid gas) in particular. Carbon dioxide is particularly preferable because it has a relatively large solubility and difference in solubility, but helium, argon, and the like are not preferable in the present invention because they have a small solubility. In order to dissolve the gas in the polymer feedstock, mechanical agitation performed with, for example, a mixer or the like may be used.

A manufacturing method of the present invention is applicable to various polymer foams, which include, for example, a polyurethane foam.

Examples of a polyisocyanate as a polyurethane feedstock, which is an example of the polymer feedstock, include aromatic isocyanates, aliphatic isocyanates, alicyclic isocyanates, and derivatives of those isocyanates. In particular, aromatic isocyanate and derivatives thereof are preferable. Tolylenediisocyanate, diphenylmethane diisocyanate, and derivatives of those isocyanates are particularly preferable.

Examples of tolylenediisocyanate and derivatives thereof include crude tolylenediisocyanate, 2,4-tolylenediisocyanate, 2,6-tolylenediisocyanate, a mixture of 2,4-tolylenediisocyanate and 2,6-tolylenediisocyanate, and those polymers modified with urea, biuret, or carbodiimide.

Diphenylmethane diisocyanate and a derivative thereof are obtained by phosgenating, for example, diaminodiphenyl methane and derivatives thereof, respectively. The derivatives of diaminodiphenyl methane include oligomers, and the following compounds can be used: pure diphenylmethane diisocyanate derived from diaminodiphenyl methane, polymeric diphenylmethane diisocyanate derived from an oligomer of diaminodiphenyl methane, and the like. For the number of functional groups of polymeric diphenylmethane diisocyanate, since a mixture of pure diphenylmethane diisocyanate and various polymeric diphenylmethane diisocyanates having different functional group numbers is usually used, the average number of the functional groups preferably ranges from 2.05 to 4.00 and more preferably 2.50 to 3.50. Furthermore, derivatives obtained by modifying those diphenylmethane diisocyanates or derivatives thereof can be used, and the obtained derivatives include, for example, urethane-modified diphenylmethane diisocyanates modified with polyol or the like, dimers obtained by the formation of urethidione, isocyanurate-modified diphenylmethane diisocyanates, carbodiimide- and/or uretonimine-modified diphenylmethane diisocyanates, allophanate-modified diphenylmethane diisocyanates, urea-modified diphenylmethane diisocyanates, and biuret-modified diphenylmethane diisocyanates. Several kinds of diphenylmethane diisocyanates and derivatives thereof may be used in combination.

Examples of a polyol component for producing the polyurethane feedstock include polyether polyol obtained by the addition polymerization of ethylene oxide and propylene oxide, polytetramethylene ether glycol, polyester polyol obtained by the condensation polymerization of an acid component and a glycol component, polyester polyol obtained by the ring-opening polymerization of caprolactone, and polycarbonate diol.

The polyether polyol obtained by the addition polymerization of ethylene oxide and propylene oxide is produced by allowing a starting material to react with ethylene oxide and propylene oxide by an addition polymerization process. Examples of the starting material include water, propylene glycol, ethylene glycol, glycerin, trimethylol propane, hexanetriol, triethanolamine, diglycerin, pentaerythritol, ethylenediamine, methyl glucoside, aromatic diamine, sorbitol, sucrose, and phosphoric acid. In particular, water, propylene glycol, ethylene glycol, glycerin, trimethylol propane, and hexanetriol are preferable. The ratio of ethylene oxide to propylene oxide and the microstructure are as follows: the percentage of ethylene oxide is preferably 2% to 95% by weight and more preferably 5% to 90% by weight, and ethylene oxide groups are preferably located at end portions. Furthermore, the ethylene oxide groups and propylene oxide groups are preferably arranged randomly in molecular chains.

The polyether polyol, which is bifunctional when the starting material is water, propylene glycol, or ethylene glycol, preferably has a weight-average molecular weight of 300 to 6000 and more preferably 400 to 3000. The polyether polyol, which is trifunctional when the starting material is glycerin, trimethylol propane, or hexanetriol, preferably has a weight-average molecular weight of 900 to 9000 and more preferably 1500 to 6000. Bifunctional polyol and trifunctional polyol may be used in combination.

The polytetramethylene ether glycol, which is another polyol component, can be obtained by the cation polymerization of, for example, tetrahydrofuran and preferably has a weight-average molecular weight of 400 to 4000 and more preferably 650 to 3000. Polytetramethylene ether glycols having different molecular weights may be used in combination.

The polytetramethylene ether glycol and the polyether polyol obtained by the addition polymerization of ethylene oxide and propylene oxide are preferably blended to be used as polyol components. In this case, the blend ratio of those components preferably ranges from 95:5 to 20:80 and more preferably 90:10 to 50:50.

In addition to those polyol components, the following compounds can be used in combination: polymer polyol obtained by modifying polyol with acrylonitrile, polyol modified with melamine by an addition reaction, diols such as butanediol, polyols such as trimethylol propane, and derivatives of those compounds.

The polyurethane feedstock may be a prepolymer prepared using polyol and polyisocyanate in advance. Such a prepolymer may be prepared according to the following procedure: polyol and polyisocyanate are placed in a suitable vessel, sufficiently mixed, and then maintained at a temperature ranging from 30° C. to 90° C., preferably 40° C to 70° C., for 6 to 240 hours, preferably 24 to 72 hours.

Examples of a catalyst used to cure the polyurethane feedstock include monoamines such as triethylamine and dimethylcyclohexylamine; diamines such as tetramethylethylenediamine, tetramethylpropanediamine, and tetramethylhexanediamine; triamines such as pentamethyldiethylenetriamine, pentamethyldipropylenetriamine, and tetramethylguanidine; cyclic amines such as triethylenediamine, dimethylpiperazine, methylethylpiperazine, methylmorpholine, dimethylaminoethyl morpholine, and dimethylimidazole; alcohol amines such as dimethylaminoethanol, dimethylaminoethoxyethanol, trimethylaminoethylethanolamine, methylhydroxyethylpiperazine, and hydroxyethylmorpholine; ether amines such as bis(dimethylaminoethyl) ether and ethylene glycol (dimethyl)aminopropyl ether; organic metal compounds such as stannous octoate, dibutyltin diacetate, dibutyltin dilaurate, dibutyltin mercaptide, dibutyltin thiocarboxylate, dibutyltin dimaleate, dioctyltin mercaptide, dioctyltin thiocarboxylate, phenylmercury propionate, and lead octoate. Those catalysts may be used alone or in combination.

When electrical conductivity is imparted to the polymer foam according to the present invention, a conductive material is added to the polymer feedstock. The conductive material is categorized into an ionic conductor and an electronic conductor. Examples of the ionic conductor include organic ionic conductors and inorganic ionic conductors, wherein the organic ionic conductors include perchlorates, chlorates, hydrochlorides, hydrobromides, hydroiodides, hydroborofluorides, sulfates, alkylsulfates, carboxylates, and sulfonates of ammonium such as tetraethylammonium, tetrabutylammonium, dodecyltrimethylammonium, ex. lauryltrimethylammonium, hexadecyltrimethylammonium, octadecyltrimethylammonium, ex. stearyltrimethylammonium, benzyltrimethylammonium, or modified aliphatic dimethylethylammonium. Examples of the electronic conductor include conductive carbon black such as Ketjenblack and acetylene black; carbon black, for rubber, such as SAF, ISAF, HAF, FEF, GPF, SRF, FT, MT; carbon black, for ink, such as oxidized carbon black; pyrolytic carbon black; graphite; conductive metal oxides such as tin oxide, titanium oxide, and zinc oxide; metals such as nickel and copper; and conductive whiskers such as a carbon whisker, a graphite whisker, a titanium carbide whisker, a conductive potassium titanate whisker, a conductive barium titanate whisker, a conductive titanium oxide whisker, and a conductive zinc oxide whisker. The volume resistivity of the polymer foam according to the present invention can be adjusted by the addition of any one of those conductive materials. When the polymer foam is used to form a transfer roller for image-forming devices, the volume resistivity is preferably controlled within a range of 10⁵ to 10¹² Ω·cm in particular because clear images can be obtained.

In addition to the conductive materials, the polymer feedstock may contain the following additive according to needs: a filler such as inorganic carbonate, a foam stabilizer such as a silicone foam stabilizer or a surfactant; an oxidation inhibitor such as phenol or phenylamine; a friction-reducing agent, or a charge control agent. Preferable examples of the silicone foam stabilizer include a dimethylpolysiloxane-polyoxyalkylene copolymer, which preferably has a dimethylpolysiloxane moiety with a molecular weight of 350 to 15000 and a polyoxyalkylene moiety with a molecular weight of 200 to 4000 in particular. The molecular structure of the polyoxyalkylene moiety is preferably an ethylene oxide polymer or an ethylene oxide-propylene oxide copolymer, and the polymer or the copolymer is preferably terminated with ethylene oxide groups. Examples of the surfactant include ionic surfactants such as cationic surfactants, anionic surfactants, and amphoteric surfactants and nonionic surfactants such as various polyethers and various polyesters. The content of the silicone foam stabilizer or the surfactant is preferably 0.1 to 10 parts by weight and more preferably 0.5 to 5 parts by weight with respect to 100 parts by weight of the polymer feedstock.

In the manufacturing method of the present invention, a mold for creating a final member shape, for example, a cylindrical mold for forming a roller member is preferably used. The polymer feedstock, a metal shaft, and the like that are integrated with each other are placed in the mold, and the polymer feedstock is preferably allowed to foam and cured. However, the method is not particularly limited and the following procedure may be used: the polymer foam is prepared so as to have a block shape, cured, and then machined so as to have a final shape. In the manufacturing method of the present invention, materials and procedures other than the above may be ordinary ones and are not particularly limited.

A member for image-forming devices according to the present invention is one that is used for manufacturing image-forming devices such as copying machines, facsimile machines, and printers. The member is not particularly limited and any member including the polymer foam manufactured by the method of the present invention is acceptable. Examples of the member include various members used for electrification, development, transfer, toner supply, cleaning, and toner control performed in image-forming devices and such members include, for example, electrifying rollers, development rollers, transfer rollers, toner supply rollers, cleaning rollers, toner control blades, and cleaning blades. Since the polymer foam obtained by the manufacturing method of the present invention has low hardness and a microcellular surface structure as described above, the polymer foam is suitable for members for dry electrophotographic systems in particular. Furthermore, a device for forming an image according to the present invention includes the member for image-forming devices according to the present invention and is not particularly limited. Examples of the device include plain paper copiers, plain paper facsimile machines, laser beam printers, color laser beam printers, and toner jet printers.

The present invention will now be described in detail with reference to examples.

### EXAMPLE

An isocyanate component having an isocyanate content of 26.2% by weight was prepared by mixing diphenylmethane diisocyanate, carbodiimide-modified diphenylmethane diisocyanate, and glycol-modified diphenylmethane diisocyanate. Polyether polyol having a weight average molecular weight of 5000 was prepared by allowing glycerin, which is a starting material, to react with ethylene oxide and propylene oxide by addition polymerization. A polyurethane feedstock was prepared by mixing 24.6 parts by weight of the isocyanate component and a polyol component containing 60 parts by weight of the polyether polyol, 40 parts by weight of polytetramethylene ether glycol having a molecular weight of 1000, 4 parts by weight of a reactive silicone foam stabilizer having a hydroxyl value of 56 mg-KOH/g, 2.5 parts by weight of black pigment, 0.4 parts by weight of ethylsulfuric acid-modified aliphatic dimethylethylammonium functioning as an electrolyte, and 0.01 parts by weight of dibutyltin dilaurate functioning as a catalyst.

Carbon dioxide gas was added to the polyurethane feedstock while the polyurethane feedstock was mechanically agitated with a mixer, whereby the gas was dissolved in the feedstock. The resulting feedstock was injected into a cylindrical mold made of metal. A metal shaft, made of sulfur free-cutting steel having a zinc coating, having a diameter of 6.0 mm and a length of 240 mm was coated with an adhesive and then placed in the mold.

The mold containing the polyurethane feedstock was placed in a hot air oven, maintained at 90° C., for four hours, thereby heat-curing the feedstock to integrate the metal shaft and a polyurethane foam into one. The resulting polyurethane foam had a diameter of 16 mm and included a foam portion with a length of 210 mm. A surface layer with a thickness of 1 mm was removed from the roller using a cylindrical grinder, whereby a roller made of the polyurethane foam was obtained. The roller had an Asker C hardness of 45 degrees.

A surface of the roller was observed at a magnification of 200× using a micro-video recorder manufactured by Keyence Corporation, whereby the cell diameter was measured. The diameter was measured for 120 cells. The average of the cell diameter data is shown in Table 1 described below. Comparative Examples 1 and 2

Rollers made of a polyurethane foam were prepared in the same manner as that described in Example except that gases shown in Table 1 were used, the gases being dissolved in the polyurethane feedstock. The average cell diameter of each roller is shown in Table 1, the diameter being determined in the same manner as that described in Example.

TABLE 1

| | | Average Cell |
|---|---|---|
| | | Diameter |
| | Kind of Gases | (μm) |
| Example | Carbon Dioxide Gas | 80 |
| Comparative | Dry Air | 120 |
| Example 1 | | |
| Comparative | Argon Gas | 120 |
| Example 2 | | |

### INDUSTRIAL APPLICABILITY

As described above, according to the present invention, a polymer foam having a microcellular surface structure can be obtained. The polymer foam is suitable for members for image-forming devices in particular. Therefore, a high-quality member, having superior surface properties, for such image-forming devices can be obtained. Furthermore, a high-performance device, including the member, for forming an image can be obtained.

1. A method for manufacturing a polymer foam formed by allowing a polymer feedstock to foam and curing the feedstock, comprising
a step of dissolving gas in the polymer feedstock, the gas being characteristic in that the solubility decreases with an increase in temperature; and
a step of heating the polymer feedstock to allow the feedstock to foam and to cure the feedstock, the heating step being subsequent to the dissolving step.

2. The method for manufacturing a polymer foam according to claim 1, wherein the gas is dissolved in the polymer feedstock at a high pressure and the feedstock is then decompressed, whereby the feedstock is allowed to foam.

3. The method for manufacturing a polymer foam according to claim 1, wherein the solubility of the gas is, at an atmospheric pressure, 70% or more at a temperature of 25° C. and 45% or less at a temperature of 80° C.

4. The method for manufacturing a polymer foam according to claim 3, wherein the gas is carbon dioxide.

5. The method for manufacturing a polymer foam according to claim 1, wherein the polymer feedstock is replaced with a polyurethane feedstock, whereby a polyurethane foam is manufactured.

6. A member for image-forming devices, comprising a polymer foam manufactured by the method according to claim 1.

7. A device for forming an image, comprising the member for image-forming devices according to claim 6.
